(19) United States
(12) Patent Application Publication
(10) Pub. No.: US 2026/0275020 A1
(43) Pub. Date: Sep. 17, 2026

(54) PROCESS FOR PREPARING AN OLEFIN-ACRYLATE BLOCK COPOLYMER

(71) Applicant: Dow Global Technologies LLC, Midland, MI (US)

(72) Inventors: Evelyn Auyeung, Houston, TX (US); Arkady L. Krasovskiy, Lake Jackson, TX (US)

(21) Appl. No.: 19/168,959

(22) PCT Filed: Sep. 27, 2024
(86) PCT No.: PCT/US2024/048861

§ 371 Date: Sep. 25, 2025

Related U.S. Application Data
(60) Provisional application No. 63/586,413, filed on Sep. 29, 2023.

(51) Int. Cl. C08F 297/08; C08F 2/00; C08F 4/659

(52) U.S. Cl. CPC C08F 297/083; C08F 2/001; C08F 4/65912; C08F 2410/01

(57) ABSTRACT

The present disclosure relates to a process for preparing an alpha-substituted acrylate, the process comprising: a) combining starting materials comprising an organometallic compound, an acrylate monomer, and a metal salt component, thereby forming a product comprising the olefin-acrylate block copolymer.

### BACKGROUND

The present disclosure is directed to a process to synthesize olefin-acrylate block copolymers. Specifically, the present disclosure describes a process for synthesizing such block copolymers using polymeryl-zinc or polymeryl-aluminum species produced via chain shuttling technology as initiators for polymerization of acrylates in the presence of metal salts or metal salt complexes. This process and the resulting block copolymer have not been realized until the disclosures of the present application.

### SUMMARY

The present disclosure is directed to a process for preparing an olefin-acrylate block copolymer, the process comprising:
a) combining starting materials comprising an organometallic compound, an acrylate monomer, and a metal salt component,
thereby forming a product comprising the olefin-acrylate block copolymer, wherein:
the metal salt component comprises a metal salt, a metal salt complex, or combinations thereof;
the organometallic compound has the formula (I):

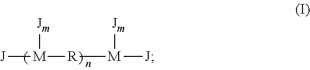

the acrylate monomer has the formula (II):

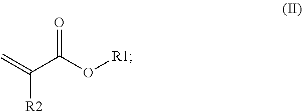

the olefin-acrylate block copolymer has the formula (III):

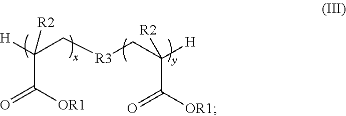

n is greater than or equal to 0;
each M independently is aluminum or zinc;
if an M is zinc, then the subscript m of the attached J is equal to 0;
if an M is aluminum, then the subscript m of the attached J is equal to 1;
each R and J independently is a C1-C26 hydrocarbyl group or a polymeryl group,
wherein each R and J may be the same or different;
each R1 independently is a C1-C30 hydrocarbyl group;
each R2 independently is hydrogen or a methyl group;
R3 is J when n is equal to 0, and R3 is R when n is greater than 0;
x is equal to 0 or a number from 2 to 500;
x is equal to 0 when n is equal to 0; and
y is a number from 2 to 500.

### BRIEF DESCRIPTION OF DRAWINGS

FIG. 1 is the ¹H NMR with diffusion measurements for Example 1, i.e., reaction of Zn(Oct)₂ and t-butyl acrylate (CuBr, 100° C.).

FIG. 2 is the ¹H NMR with diffusion measurements for Example 2, i.e., reaction of Zn(Oct)₂ and t-butyl acrylate (CuI)₄·3[(CH₃)₂S], 100° C.).

FIG. 3 is the ¹H NMR with diffusion measurements for Example 3, i.e., reaction of Zn(Oct)₂ and t-butyl acrylate (CuCN·2LiCl, 100° C.).

FIG. 4 is the GPC overlay of polymers made in Example 4 in the presence of (CuI)₄·3[(CH₃)₂S].

FIG. 5 is the TGIC overlay of polymer made in Example 4 in the presence of (CuI)₄·3[(CH₃)₂S].

FIG. 6 is the Transmission electron microscopy comparison of a PE/poly(2EHA) physical blend and a polymer produced by Example 4, i.e., reaction of ZnPE₂ and 90 equiv 2EHA in the presence of (CuI)₄·3[(CH₃)₂S].

### DETAILED DESCRIPTION

### Definitions

All references to the Periodic Table of the Elements herein shall refer to the Periodic Table of the Elements, published and copyrighted by CRC Press, Inc., 2003. Also, any references to a Group or Groups shall be to the Group or Groups reflected in this Periodic Table of the Elements using the IUPAC system for numbering groups.

Unless stated to the contrary, implicit from the context, or customary in the art, all parts and percents are based on weight.

For purposes of United States patent practice, the contents of any patent, patent application, or publication referenced herein are hereby incorporated by reference in their entirety (or the equivalent US version thereof is so incorporated by reference) especially with respect to the disclosure of synthetic techniques, definitions (to the extent not inconsistent with any definitions provided herein) and general knowledge in the art.

The numerical ranges disclosed herein include all values from, and including, the lower and upper value. For ranges containing explicit values (e.g., 1, or 2, or 3 to 5, or 6, or 7), any subrange between any two explicit values is included (e.g., 1 to 2; 2 to 6; 5 to 7; 3 to 7; 5 to 6; etc.). The numerical ranges disclosed herein further include the fractions between any two explicit values.

The terms “comprising,” “including,” “having” and their derivatives are not intended to exclude the presence of any additional component, step or procedure, whether or not the same is specifically disclosed. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination.

As used herein, the terms “hydrocarbyl,” “hydrocarbyl group,” and like terms refer to compounds composed entirely of hydrogen and carbon, including aliphatic, aromatic, acyclic, cyclic, polycyclic, branched, unbranched, saturated, and unsaturated compounds. The terms “hydrocarbyl,” “hydrocarbyl group,” “alkyl,” “alkyl group,” “aryl,” “aryl group,” and like terms are intended to include every possible isomer, including every structural isomer or stereoisomer. The terms “hydrocarbyl,” “hydrocarbyl group,” and like terms will be understood to be hydrocarbylene or hydrocarbylene group when, for example, said terms refer to a group sandwiched between two metal atoms.

The term “cyclic” refers to a series of atoms in a polymer or compound where such a series includes one or more rings. Accordingly, the term “cyclic hydrocarbyl group” refers to a hydrocarbyl group that contains one or more rings. A “cyclic hydrocarbyl group,” as used herein, may contain acyclic (linear or branched) portions in addition to the one or more rings.

The term “catalyst” is used interchangeably with “procatalyst,” “precatalyst,” “catalyst precursor,” “transition metal catalyst,” “transition metal catalyst precursor,” “polymerization catalyst,” “polymerization catalyst precursor,” “transition metal complex,” “transition metal compound,” “metal complex,” “metal compound,” “complex,” “metal-ligand complex,” and like terms.

“Co-catalyst” refers to a compound that can activate certain procatalysts to form an active catalyst capable of polymerization of unsaturated monomers. The term “co-catalyst” is used interchangeably with “activator” and like terms.

“Active catalyst,” “active catalyst composition,” and like terms refer to a transition metal compound that is, with or without a co-catalyst, capable of polymerization of unsaturated monomers. An active catalyst may be a “procatalyst” that becomes active to polymerize unsaturated monomers without a co-catalyst. Alternatively, an active catalyst may a “procatalyst” that becomes active, in combination with a co-catalyst, to polymerize unsaturated monomers.

The term “polymer” refers to a material prepared by reacting (i.e., polymerizing) a set of monomers, wherein the set is a homogenous (i.e., only one type) set of monomers or a heterogeneous (i.e., more than one type) set of monomers. The term polymer as used herein includes the term “homopolymer,” which refers to polymers prepared from a homogenous set of monomers, and the term “interpolymer” as defined below.

The term “interpolymer” refers to a polymer prepared by the polymerization of at least two different types of monomers. This term include both “copolymers,” i.e., polymers prepared from two different types of monomers, and polymers prepared from more than two different types of monomers, e.g., terpolymers, tetrapolymers, etc. This term also embraces all forms of interpolymers, such as random, block, homogeneous, heterogeneous, etc.

An “ethylene-based polymer” is a polymer that contains a majority amount of polymerized ethylene, based on the weight of the polymer, and, optionally, may further contain polymerized units of at least one comonomer. An “ethylene-based interpolymer” is an interpolymer that contains, in polymerized form, a majority amount of ethylene, based on the weight of the interpolymer, and further contains polymerized units of at least one comonomer. An “ethylene homopolymer” is a polymer that comprises repeating units derived from ethylene but does not exclude residual amounts of other components.

The term “ethylene/alpha-olefin interpolymer,” as used herein, refers to a polymer that comprises, in polymerized form, a majority weight percent of ethylene (based on the weight of the interpolymer), and at least one comonomer that is an alpha-olefin. The ethylene/alpha-olefin interpolymer may be a random or block interpolymer. The terms “ethylene/alpha-olefin copolymer” and “ethylene/alpha-olefin multi-block interpolymer” are covered by the term “ethylene/alpha-olefin interpolymer.”

The term “ethylene/alpha-olefin copolymer,” as used herein, refers to a copolymer that comprises, in polymerized form, a majority weight percent of ethylene (based on the weight of the copolymer), and a comonomer that is an alpha-olefin, where ethylene and the alpha-olefin are the only two monomer types. The ethylene/alpha-olefin copolymer does not exclude residual amounts of other components. The ethylene/alpha-olefin copolymer may be a random or block copolymer.

The term “ethylene/alpha-olefin multi-block interpolymer” or “olefin block copolymer,” as used herein, refers to an interpolymer that includes ethylene and one or more copolymerizable alpha-olefin comonomers in polymerized form, characterized by multiple blocks or segments of two or more (preferably three or more) polymerized monomer units, the blocks or segments differing in chemical or physical properties. Specifically, this term refers to a polymer comprising two or more (preferably three or more) chemically distinct regions or segments (referred to as “blocks”) joined in a linear manner, that is, a polymer comprising chemically differentiated units which are joined (covalently bonded) end-to-end with respect to polymerized functionality, rather than in pendent or grafted fashion. The blocks differ in the amount or type of comonomer incorporated therein, the density, the amount of crystallinity, the type of crystallinity (e.g., polyethylene versus polypropylene), the crystallite size attributable to a polymer of such composition, the type or degree of tacticity (isotactic or syndiotactic), region-regularity or region-irregularity, the amount of branching, including long chain branching or hyper-branching, the homogeneity, and/or any other chemical or physical property. The block copolymers are characterized by unique distributions of both polymer polydispersity (PDI or Mw/Mn) and block length distribution, e.g., based on the effect of the use of a shuttling agent(s) in combination with catalyst systems. Non-limiting examples of the olefin block copolymers of the present disclosure, as well as the processes for preparing the same, are disclosed in U.S. Pat. Nos. 7,858,706 B2, 8,198,374 B2, 8,318,864 B2, 8,609,779 B2, 8,710,143 B2, 8,785,551 B2, and 9,243,090 B2, which are all incorporated herein by reference in their entirety.

The term “block composite” (“BC”) refers to a polymer comprising three polymer components: (i) an ethylene-based polymer (EP) having an ethylene content from 10 mol % to 90 mol % (a soft copolymer), based on the total moles of polymerized monomer units in the ethylene-based polymer (EP); (ii) an alpha-olefin-based polymer (AOP) having an alpha-olefin content of greater than 90 mol % (a hard copolymer), based on the total moles of polymerized monomer units in the alpha-olefin-based polymer (AOP); and (iii) a block copolymer (diblock copolymer) having an ethylene block (EB) and an alpha-olefin block (AOB); wherein the ethylene block of the block copolymer is the same composition as the EP of component (i) of the block composite and the alpha-olefin block of the block copolymer is the same composition as the AOP of component (ii) of the block composite. Additionally, in the block composite, the compositional split between the amount of EP and AOP will be essentially the same as that between the corresponding blocks in the block copolymer. Non-limiting examples of the block composites of the present disclosure, as well as processes for preparing the same, are disclosed in U.S. Pat. Nos. 8,686,087 and 8,716,400, which are incorporated herein by reference in their entirety.

The term “specified block composite” (“SBC”) refers to a polymer comprising three polymer components: (i) an ethylene-based polymer (EP) having an ethylene content from 78 mol % to 90 mol % (a soft copolymer), based on the total moles of polymerized monomer units in the ethylene-based polymer (EP); (ii) an alpha-olefin-based polymer (AOP) having an alpha-olefin content of from 61 mol % to 90 mol % (a hard copolymer), based on the total moles of polymerized monomer units in the alpha-olefin-based polymer (AOP); and (iii) a block copolymer (diblock copolymer) having an ethylene block (EB) and an alpha-olefin block (AOB); wherein the ethylene block of the block copolymer is the same composition as the EP of component (i) of the specified block composite and the alpha-olefin block of the block copolymer is the same composition as the AOP of component (ii) of the specified block composite. Additionally, in the specified block composite, the compositional split between the amount of EP and AOP will be essentially the same as that between the corresponding blocks in the block copolymer. Non-limiting examples of the specified block composites of the present disclosure, as well as processes for preparing the same, are disclosed in WO 2017/044547, which is incorporated herein by reference in its entirety.

The term “crystalline block composite” (“CBC”) refers to polymers comprising three components: (i) a crystalline ethylene based polymer (CEP) having an ethylene content of greater than 90 mol %, based on the total moles of polymerized monomer units in the crystalline ethylene based polymer (CEP); (ii) a crystalline alpha-olefin based polymer (CAOP) having an alpha-olefin content of greater than 90 mol %, based on the total moles of polymerized monomer units in the crystalline alpha-olefin based copolymer (CAOP); and (iii) a block copolymer comprising a crystalline ethylene block (CEB) and a crystalline alpha-olefin block (CAOB); wherein the CEB of the block copolymer is the same composition as the CEP of component (i) of the crystalline block composite and the CAOB of the block copolymer is the same composition as the CAOP of component (ii) of the crystalline block composite. Additionally, in the crystalline block composite, the compositional split between the amount of CEP and CAOP will be essentially the same as that between the corresponding blocks in the block copolymer. Non-limiting examples of the crystalline block composites of the present disclosure, as well as the processes for preparing the same, are disclosed in U.S. Pat. No. 8,822,598 B2 and WO 2016/01028961 A1, which are incorporated herein by reference in its entirety.

A “propylene-based polymer” is a polymer that contains a majority amount of polymerized propylene, based on the weight of the polymer, and, optionally, may further contain polymerized units of at least one comonomer. A “propylene-based interpolymer” is an interpolymer that contains, in polymerized form, a majority amount of propylene, based on the weight of the interpolymer, and further contains polymerized units of at least one comonomer. A “propylene homopolymer” is a polymer that comprises repeating units derived from propylene but does not exclude residual amounts of other components.

The term “propylene/alpha-olefin interpolymer,” as used herein, refers to a polymer that comprises, in polymerized form, a majority weight percent of propylene (based on the weight of the interpolymer), and at least one comonomer that is an alpha-olefin (where ethylene is considered an alpha-olefin). The propylene/alpha-olefin interpolymer may be a random or block interpolymer. The term “propylene/alpha-olefin interpolymer” includes the term “propylene/alpha-olefin copolymer.”

The term “propylene/alpha-olefin copolymer,” as used herein, refers to a copolymer that comprises, in polymerized form, a majority weight percent of propylene (based on the weight of the copolymer), and a comonomer that is an alpha-olefin, wherein propylene and the alpha-olefin are the only two monomer types. The propylene/alpha-olefin copolymer does not exclude residual amounts of other components. The propylene/alpha-olefin copolymer may be a random or block copolymer.

The terms “polymeryl,” “polymeryl group” and like terms refer to a polymer missing one or two hydrogen atoms, where the polymer may include aliphatic, aromatic, acyclic, cyclic, polycyclic, branched, unbranched, saturated, and/or unsaturated compounds or groups but does not exclude residual amounts of other components.

### Acrylate Monomer

The starting materials of step a) of the process of the present disclosure comprise an acrylate monomer.

In certain embodiments, the acrylate monomer has the formula (II):

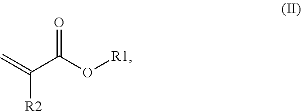

wherein:
each R1 independently is a C1-C30 hydrocarbyl group; and
each R2 independently is hydrogen or a methyl group.

In certain embodiments, each R1 independently is a C1-C30 hydrocarbyl group that may be linear, branched, or cyclic. In further embodiments, each R1 independently is a C1-C30 alkyl group that may be linear, branched, or cyclic. For example, R1 at each occurrence may be a linear, branched, or cyclic alkyl group comprising from 1 to 30 carbon atoms, or from 1 to 20 carbon atoms, or from 1 to 10 carbon atoms, or from 1 to 8 carbon atoms, or from 1 to 6 carbon atoms, or from 1 to 4 carbon atoms.

### Metal Salt Component

The starting materials of step a) of the process of the present disclosure comprise a metal salt component, wherein the metal salt component comprises a metal salt, a metal salt complex, or combinations thereof;

In certain embodiments, the metal salt or metal salt complex is selected from transition metal salts or complexes. In certain embodiments, the metal salt or metal salt complex is selected from the group consisting of a copper salt or copper salt complex, an iron salt or iron salt complex, a manganese salt or manganese salt complex, and combinations thereof.

In further embodiments, the metal salt or metal salt complex is a copper salt or copper salt complex. In further embodiments, the metal salt or metal salt complex is a copper salt or copper salt complex selected from the group consisting of: CuBr; CuCN·2LiCl; (CuI)₄·3[(CH₃)₂S]; CuBr₂; CuBr·CH₃SCH₃; CuCl; CuCl₂; CuTC (copper thiophene-2-carboxylate); Cu(OAc); CuSPh; [C₆H₁₁(CH₂)₃CO₂]₂Cu; CuF₂; C₁₂H₂₂CuO₁₄; Cu(OH)₂; CuI; Cu(NO₃)₂; CuSCN; and combinations thereof.

### Organometallic Compound

The starting materials of step a) of the process of the present disclosure comprise an organometallic compound of the formula (I):

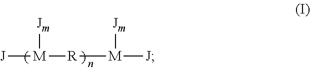

wherein:
n is greater than or equal to 0;
each M independently is aluminum or zinc;
if an M is zinc, then the subscript m of the attached J is equal to 0;
if an M is aluminum, then the subscript m of the attached J is equal to 1;
each R and J independently is a C1-C26 hydrocarbyl group or a polymeryl group,
wherein each R and J may be the same or different.

As understood by one of ordinary skill in the art, if an M in formula (I) is zinc, then said M is divalent and, therefore, the attached J with the subscript m is not present in the organometallic compound of the formula (I) since the subscript m is equal to 0. If an M in formula (I) is aluminum, then said M is trivalent and, therefore, the attached J with the subscript m is present in the organometallic compound of the formula (I) since the subscript m is equal to 1.

As further understood by one of ordinary skill in the art, when n is equal to 0, the organometallic compound of the formula (I) has the following structure (Ia), where M is aluminum or zinc. If M is zinc, then M is divalent and the attached J with the subscript m is not present since the subscript m is equal to 0. If M is aluminum, then M is trivalent and the attached J with the subscript m is present since the subscript m is equal to 1. J is any of the embodiments described herein.

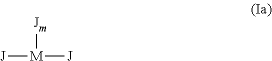

In certain embodiments, each R and/or each J of the organometallic compound of the formula (I) independently is a C1-C26 hydrocarbyl group. In certain embodiments, each R and/or each J of the organometallic compound of the formula (I) independently is a C1-C26 hydrocarbyl group that may be linear, branched, or cyclic. In further embodiments, each R and/or each J of the organometallic compound of the formula (I) independently is a C1-C26 alkyl group that may be linear, branched, or cyclic. For example, each R and/or each J of the organometallic compound of the formula (I) may independently be a linear, branched, or cyclic alkyl group comprising from 3 to 26 carbon atoms, or from 3 to 10 carbon atoms, or from 3 to 8 carbon atoms.

In some embodiments, each R and/or each J of the organometallic compound of the formula (I) independently is a polymeryl group. In further embodiments, each R and/or J each of the organometallic compound of the formula (I) independently is a polymeryl group that has a number average molecular weight of greater than 365 g/mol. In further embodiments, each R and/or each J of the organometallic compound of the formula (I) independently is a polymeryl group that has a number average molecular weight from greater than 365 g/mol to 10,000,000 g/mol, or from greater than 365 g/mol to 5,000,000 g/mol, or from greater than 365 g/mol to 1,000,000 g/mol, or from greater than 365 g/mol to 750,000 g/mol, or from greater than 365 g/mol to 500,000 g/mol, or from greater than 365 g/mol to 250,000 g/mol.

In further embodiments, each R and/or each J of the organometallic compound of the formula (I) independently is a polymeryl group that has a density from 0.850 to 0.965 g/cc, or from 0.860 to 0.950 g/cc, or from 0.865 to 0.925 g/cc.

In further embodiments, each R and/or each J of the organometallic compound of the formula (I) independently is a polymeryl group that has a melt index (I2) from 0.01 to 2,000 g/10 minutes, or from 0.01 to 1,500 g/10 minutes, or from 0.1 to 1,000 g/10 minutes, or from 0.1 to 500 g/10 minutes, or from 0.1 to 100 g/10 minutes.

In further embodiments, each R and/or each J of the organometallic compound of the formula (I) independently is a polymeryl group that has a number average molecular weight distribution (Mw/Mn or PDI) from 1 to 10, or from 1 to 7, or from 1 to 5, or from 2 to 4.

In certain embodiments, each R and/or each J of the organometallic compound of the formula (I) independently is an ethylene homopolymeryl group comprising units derived from ethylene.

In certain embodiments, each R and/or each J of the organometallic compound of the formula (I) independently is an ethylene/alpha-olefin interpolymeryl group comprising units derived from ethylene and at least one C3-C30 alpha-olefin. The C3-C30 alpha-olefin may be, for example, 1-butene, 4-methyl-1-pentene, 1-hexene, 1-octene, 1-decene, 1-dodecene, 1-tetradecene, 1-hexadecene, or 1-octadecene.

In certain embodiments, each R and/or each J of the organometallic compound of the formula (I) independently is an ethylene/alpha-olefin copolymeryl group comprising units derived from ethylene and a C3-C30 alpha-olefin. The C3-C30 alpha-olefin may be, for example, propylene, 1-butene, 4-methyl-1-pentene, 1-hexene, 1-octene, 1-decene, 1-dodecene, 1-tetradecene, 1-hexadecene, or 1-octadecene.

In certain embodiments, each R and/or each J of the organometallic compound of the formula (I) independently is an ethylene/alpha-olefin multi-block interpolymeryl group or olefin block copolymeryl group as defined herein.

In further embodiments, each R and/or each J of the organometallic compound of the formula (I) independently is a polymeryl group of a block composite, a specified block composite, or a crystalline block composite, as defined herein.

In certain embodiments, each R and/or each J of the organometallic compound of the formula (I) independently is a propylene homopolymeryl group comprising units derived from propylene.

In certain embodiments, each R and/or each J of the organometallic compound of the formula (I) independently is a propylene/alpha-olefin interpolymeryl group comprising units derived from propylene and at least one comonomer that is ethylene or a C3-C30 alpha-olefin. The C3-C30 alpha-olefin may be, for example, propylene, 1-butene, 4-methyl-1-pentene, 1-hexene, 1-octene, 1-decene, 1-dodecene, 1-tetradecene, 1-hexadecene, or 1-octadecene.

In certain embodiments, each R and/or each J of the organometallic compound of the formula (I) independently is a propylene/alpha-olefin copolymeryl group comprising units derived from propylene and a comonomer that is ethylene or a C3-C30 alpha-olefin. The C3-C30 alpha-olefin may be, for example, propylene, 1-butene, 4-methyl-1-pentene, 1-hexene, 1-octene, 1-decene, 1-dodecene, 1-tetradecene, 1-hexadecene, or 1-octadecene.

Regarding the embodiments wherein each R and/or each J of the organometallic compound of the formula (I) is a polymeryl group, the organometallic compound of the formula (I) may be prepared by a process (al), wherein the process (al) comprises combining starting materials comprising:
i) an olefin monomer component;
ii) a catalyst; and
iii) a chain shuttling agent,
thereby forming a solution or slurry comprising the organometallic compound of the formula (I).

Starting material i), the olefin monomer component, comprises one or more olefin monomers. Suitable olefin monomers include straight chain or branched alpha-olefins of 2 to 30 carbon atoms, alternatively 2 to 20 carbon atoms, such as ethylene, propylene, 1-butene, 3-methyl-1-butene, 1-pentene, 1-hexene, 4-methyl-1-pentene, 3-methyl-1-pentene, 1-octene, 1-decene, 1-dodecene, 1-tetradecene, 1-hexadecene, 1-octadecene, and 1-eicosene; cycloolefins of 3 to 30, alternatively 3 to 20 carbon atoms such as cyclopentene, cycloheptene, norbornene, 5-methyl-2-norbornene, tetracyclododecene, and 2-methyl-1,4,5,8-dimethano-1,2,3,4,4a,5,8,8a-octahydronaphthalene. Suitable olefin monomers are disclosed for example, at col. 16, lines 5-36 of U.S. Pat. No. 7,858,706 and at col. 12, lines 7 to 41 of U.S. Pat. No. 8,053,529, which are hereby incorporated by reference. In certain embodiments, starting material i) may comprise ethylene and optionally one or more olefin monomers other than ethylene, such as propylene or 1-octene.

Regarding starting material ii), suitable catalysts include any compound or combination of compounds that is adapted for preparing polymers of the desired composition or type. One or more catalysts may be used. For example, first and second olefin polymerization catalysts may be used for preparing polymers differing in chemical or physical properties. Both heterogeneous and homogeneous catalysts may be employed. Examples of heterogeneous catalysts include Ziegler-Natta compositions, especially Group 4 metal halides supported on Group 2 metal halides or mixed halides and alkoxides and chromium or vanadium based catalysts. Alternatively, for ease of use and for production of narrow molecular weight polymer segments in solution, the catalysts may be homogeneous catalysts comprising an organometallic compound or metal complex, such as compounds or complexes based on metals selected from Groups 3 to 15 or the Lanthanide series of the Periodic Table of the Elements. Starting material ii) may further comprise a cocatalyst in addition to the catalyst. The cocatalyst may be a cation forming co-catalyst, a strong Lewis Acid, or combination thereof. Suitable catalysts and cocatalysts are disclosed, for example, at col. 19, line 45 to col. 51, line 29 of U.S. Pat. No. 7,858,706, and col. 16, line 37 to col. 48, line 17 of U.S. Pat. No. 8,053,529, which are hereby incorporated by reference. Suitable procatalysts that may also be added include but are not limited to those disclosed in PCT Publications WO 2005/090426, WO 2005/090427, WO 2007/035485, WO 2009/012215, WO 2014/105411, WO 2017/173080, U.S. Patent Publication Nos. 2006/0199930, 2007/0167578, 2008/0311812, and U.S. Pat. Nos. 7,355,089 B2, 8,058,373 B2, and 8,785,554 B2, which are hereby incorporated by reference.

In certain embodiments, regarding starting material iii), the chain shuttling agent has the formula X₂Zn, where each X is independently a hydrocarbyl group of 1 to 20 carbon atoms. The hydrocarbyl group for X has 1 to 20 carbon atoms, alternatively 2 to 12 carbon atoms. The hydrocarbyl group for X may be an alkyl group, which may be linear or branched. X may be an alkyl group exemplified by ethyl, propyl, octyl, and combinations thereof. Suitable chain shuttling agents include dialkyl zinc compounds, such as diethylzinc. Suitable chain shuttling agents are disclosed at col. 16, line 37 to col. 19, line 44 of U.S. Pat. No. 7,858,706 and col. 12, line 49 to col. 14, line 40 of U.S. Pat. No. 8,053,529, which are hereby incorporated by reference.

In certain embodiments, regarding starting material iii), the chain shuttling agent has the formula X₃Al, where each X is independently a hydrocarbyl group of 1 to 20 carbon atoms. The hydrocarbyl group for X has 1 to 20 carbon atoms, alternatively 2 to 12 carbon atoms. The hydrocarbyl group for X may be an alkyl group, which may be linear or branched. X may be an alkyl group exemplified by ethyl, propyl, octyl, and combinations thereof. Suitable chain shuttling agents include trialkyl aluminum compounds, such as triethylaluminum.

In further embodiments, regarding starting material iii), the chain shuttling agent is a dual-headed chain shuttling agent that may be capped or uncapped. Suitable dual-headed chain shuttling agents are disclosed in PCT Publications WO2019/133699, WO2019/133705, WO2018/064553, WO2018/064540, and WO2018/064546, which are incorporated herein by reference.

A non-limiting example of a capped dual-headed chain shuttling agent is below:

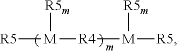

wherein:
n is greater than or equal to 0;
each M independently is aluminum or zinc;
R4 is a linking group composed of a linear, branched, or cyclic C₄ to C₁₀₀ hydrocarbylene group that optionally includes at least one heteroatom and that is aliphatic or aromatic,
wherein R4 comprises two points of attachment to metal atoms and at least one of the two points of attachments is —CH₂—; and
each R5 group is independently a substituted or unsubstituted aryl group or a substituted or unsubstituted cyclic alkyl group containing, optionally, at least one heteroatom, and two R5 groups attached to the same metal atom can be optionally covalently linked together.

In certain embodiments, the each R5 group of the capped dual-headed chain shuttling agent is independently selected from the group consisting of the following structures CG5 to CG13, where the symbol * used herein refers to a carbon-metal bond serving as the point of attachment between the carbon of a substituent group and the metal:

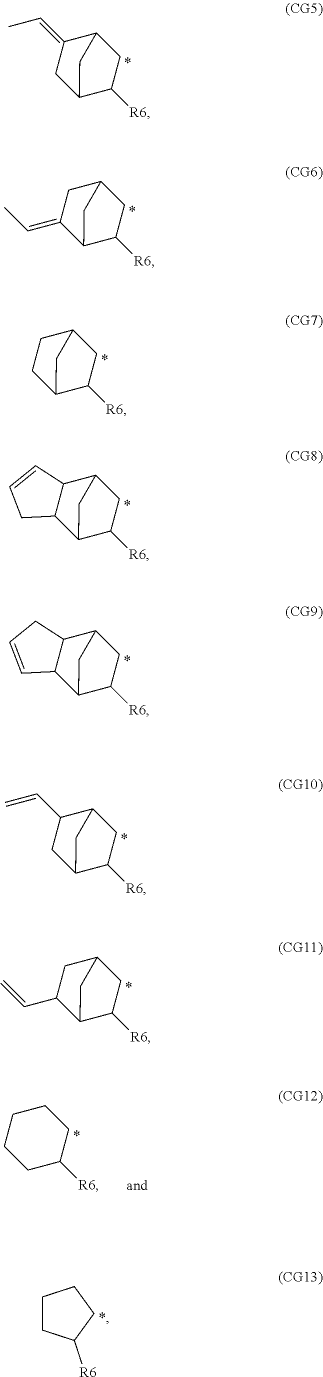

wherein each R6 is independently hydrogen or a C1 to C20 alkyl group.

A non-limiting example of an uncapped dual-headed chain shuttling agent is below:

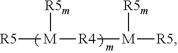

wherein:
n is greater than or equal to 0;
each M independently is aluminum or zinc;
R4 is a linking group composed of a linear, branched, or cyclic C₄ to C₁₀₀ hydrocarbylene group that optionally includes at least one heteroatom and that is aliphatic or aromatic,
wherein R4 comprises two points of attachment to metal atoms and at least one of the two points of attachments is —CH₂—; and
each R5 group is independently a C1 to C20 alkyl group.

The starting materials for preparing the organometallic compound of the formula (I) may optionally further comprise one or more additional starting materials selected from: iv) a solvent, vi) a scavenger, vii) an adjuvant, and viii) a polymerization aid. Toluene and Isopar™ E are examples of solvents for starting material iv). Isopar™ E is an isoparaffin fluid, typically containing less than 1 ppm benzene and less than 1 ppm sulfur, which is commercially available from ExxonMobil Chemical Company.

The process conditions and equipment for preparing the organometallic compound of the formula (I) are known in the art and are disclosed, for example in U.S. Pat. Nos. 7,858,706 and 8,053,529, which are hereby incorporated by reference. For example, the process (al) may be characterized as polymerization that is desirably carried out as a continuous polymerization, preferably a continuous, solution polymerization, in which catalyst components, shuttling agent(s), monomers, and optionally solvent, adjuvants, scavengers, and polymerization aids are continuously supplied to the reaction zone and polymer product continuously removed there from. Within the scope of the terms “continuous” and “continuously” as used in this context are those processes in which there are intermittent additions of reactants and removal of products at small regular or irregular intervals, so that, over time, the overall process is substantially continuous.

The polymerization can be advantageously employed as a high pressure, solution, slurry, or gas phase polymerization process. For a solution polymerization process it is desirable to employ homogeneous dispersions of the catalyst components in a liquid diluent in which the polymer is soluble under the polymerization conditions employed. One such process utilizing an extremely fine silica or similar dispersing agent to produce such a homogeneous catalyst dispersion where either the metal complex or the cocatalyst is only poorly soluble is disclosed in U.S. Pat. No. 5,783,512. A solution process to prepare the novel polymers of the present invention, especially a continuous solution process is preferably carried out at a temperature between 80° C. and 250° C., more preferably between 100° C. and 210° C., and most preferably between 110° C. and 210° C. A high pressure process is usually carried out at temperatures from 100° C. to 400° C. and at pressures above 500 bar (50 MPa). A slurry process typically uses an inert hydrocarbon diluent and temperatures of from 0° C. up to a temperature just below the temperature at which the resulting polymer becomes substantially soluble in the inert polymerization medium. Preferred temperatures in a slurry polymerization are from 30° C., preferably from 60° C. up to 115° C., preferably up to 100° C. Pressures typically range from atmospheric (100 kPa) to 500 psi (3.4 MPa).

### Preparing an Olefin-Acrylate Block Copolymer

The present process is directed to preparing an olefin-acrylate block copolymer. In certain embodiments, the olefin-acrylate block copolymer has the formula (III):

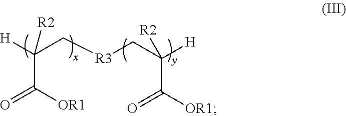

wherein:
R3 is a C1-C26 hydrocarbyl group or a polymeryl group;
each R1 independently is a C1-C30 hydrocarbyl group;
each R2 independently is hydrogen or a methyl group;
x is equal to 0 or a number from 2 to 500; and
y is a number from 2 to 500.

The R3 group of the olefin-acrylate block copolymer of the formula (III) is the same as and includes all embodiments of the R or J group of the organometallic compound of the formula (I). Each of the R1 and R2 groups of the olefin-acrylate block copolymer of the formula (III) is the same as and includes all embodiments of the R1 and R2 groups of the acrylate monomer of the formula (II).

As understood by one of ordinary skill in the art, when x is equal to 0, the olefin-acrylate block copolymer of the formula (III) has the following formula (IIIa), where each R1 independently is a C1-C30 hydrocarbyl group; each R2 independently is hydrogen or a methyl group; R3 is a C1-C26 hydrocarbyl group or a polymeryl group; and y is a number from 2 to 500:

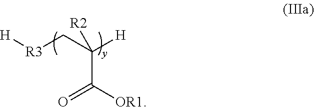

In certain embodiments, step a) of the process of the present disclosure may be performed neat. In further embodiments, the starting materials in step a) of the process of the present disclosure further comprise a hydrocarbon solvent. In further embodiments, the starting materials in step a) of the process of the present disclosure further comprise a hydrocarbon solvent that is a non-aromatic hydrocarbon solvent.

In some embodiments, step a) of the process of the present disclosure is performed at a temperature that is above the melting temperature of the R group as defined herein. For example and without limitation, step a) of the process of the present disclosure may be performed at a temperature from 15° C. to 200° C. or 15° C. to 100° C.

Specific embodiments of the present disclosure include but are not limited to the following:

1. A process for preparing an olefin-acrylate block copolymer, the process comprising:
a) combining starting materials comprising an organometallic compound, an acrylate monomer, and a metal salt component,
thereby forming a product comprising the olefin-acrylate block copolymer.

2. A process for preparing an olefin-acrylate block copolymer, the process comprising:
a) combining starting materials comprising an organometallic compound, an acrylate monomer, and a metal salt component,
thereby forming a product comprising the olefin-acrylate block copolymer, wherein:
the metal salt component comprises a metal salt, a metal salt complex, or
combinations thereof;
the organometallic compound has the formula (I):

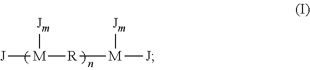

the acrylate monomer has the formula (II):

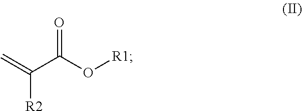

the olefin-acrylate block copolymer has the formula (III):

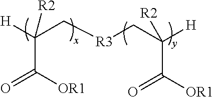

n is greater than or equal to 0;
each M independently is aluminum or zinc;
if an M is zinc, then the subscript m of the attached J is equal to 0;
if an M is aluminum, then the subscript m of the attached J is equal to 1;
each R and J independently is a C1-C26 hydrocarbyl group or a polymeryl group,
wherein each R and J may be the same or different;
each R1 independently is a C1-C30 hydrocarbyl group;
each R2 independently is hydrogen or a methyl group;
R3 is J when n is equal to 0, and R3 is R when n is greater than 0;
x is equal to 0 or a number from 2 to 500;
x is equal to 0 when n is equal to 0; and
y is a number from 2 to 500.

3. The process of embodiment 1 or 2, wherein the starting materials of step a) further comprise a solvent.

4. The process of any of the previous embodiments, wherein the metal salt or metal salt complex is selected from the group consisting of a transition metals salts or complexes, copper salt or copper salt complex, an iron salt or iron salt complex, a manganese salt or manganese salt complex, and combinations thereof.

5. The process of any of the previous embodiments, wherein the transition metal salt or metal salt complex is a copper salt or copper salt complex.

6. The process of any of the previous embodiments, wherein the metal salt or metal salt complex is a copper salt or copper salt complex selected from the group consisting of: CuBr; CuCN·2LiCl; (CuI)₄·3[(CH₃)₂S]; CuBr₂; CuBr·CH₃SCH₃; CuCl; CuCl₂; CuTC (copper thiophene-2-carboxylate); Cu(Oac); CuSPh; [C₆H₁₁(CH₂)₃CO₂]₂Cu; CuF₂; C₁₂H₂₂CuO₁₄; Cu(OH)₂; CuI; Cu(NO₃)₂; CuSCN; and combinations thereof.

7. The process of any of the previous embodiments, wherein each R1 independently is a C1-C30, or C1-C10, or C1-C8, or C1-C4 alkyl group that is linear, branched, or cyclic.

8. The process of any of the previous embodiments, wherein each R independently is a C1-C26 hydrocarbyl group.

9. The process of embodiment 8, wherein each R independently is a C1-C26, or C1-C10, or C1-C8 alkyl group that is linear, branched, or cyclic.

10. The process of any of embodiments 1-7, wherein each R independently is a polymeryl group.

11. The process of embodiment 10, wherein the polymeryl group is an ethylene-based polymeryl group.

12. The process of embodiment 11, wherein the polymeryl group is an ethylene homopolymeryl group comprising units derived from ethylene.

13. The process of embodiment 11, wherein the polymeryl group is an ethylene/alpha-olefin interpolymeryl group comprising units derived from ethylene and a C3-C30 alpha-olefin

14. The process of embodiment 13, wherein the polymeryl group is an ethylene/alpha-olefin copolymeryl group comprising units derived from ethylene and a C3-C30 alpha-olefin.

15. The process of embodiments 13 or 14, wherein the C3-C30 alpha-olefin is selected from the group consisting of propylene, 1-butene, 1-hexene, and 1-octene.

16. The process of embodiment 11, wherein the polymeryl group is an ethylene/alpha-olefin multiblock interpolymeryl group.

17. The process of embodiment 11, wherein the polymeryl group is selected from the group consisting of a polymeryl group of a block composite, a polymeryl group of a specified block composite, and a polymeryl group of a crystalline block composite.

18. The process of embodiment 10, wherein the polymeryl group is a propylene-based polymeryl group.

19. The process of embodiment 18, wherein the polymeryl group is a propylene homopolymeryl group comprising units derived from propylene.

20. The process of embodiment 18, wherein the polymeryl group is a propylene/alpha-olefin interpolymeryl group comprising units derived from propylene and either ethylene or a C4-C30 alpha-olefin.

21. The process of embodiment 20, wherein the polymeryl group is a propylene/alpha-olefin copolymeryl group comprising units derived from propylene and either ethylene or a C4-C30 alpha-olefin.

22. The process of embodiment 20 or 21, wherein the C4-C30 alpha-olefin is selected from the group consisting of 1-butene, 1-hexene, and 1-octene.

23. The process of any of the previous embodiments, wherein each J independently is a C1-C26 hydrocarbyl group.

24. The process of embodiment 23, wherein each J independently is a C1-C26, or C1-C10, or C1-C8 alkyl group that is linear, branched, or cyclic.

25. The process of any of embodiments 1-22, wherein each J independently is a polymeryl group.

26. The process of embodiment 25, wherein the polymeryl group is an ethylene-based polymeryl group.

27. The process of embodiment 26, wherein the polymeryl group is an ethylene homopolymeryl group comprising units derived from ethylene.

28. The process of embodiment 26, wherein the polymeryl group is an ethylene/alpha-olefin interpolymeryl group comprising units derived from ethylene and a C3-C30 alpha-olefin.

29. The process of embodiment 28, wherein the polymeryl group is an ethylene/alpha-olefin copolymeryl group comprising units derived from ethylene and a C3-C30 alpha-olefin.

30. The process of embodiments 28 or 29, wherein the C3-C30 alpha-olefin is selected from the group consisting of propylene, 1-butene, 1-hexene, and 1-octene.

31. The process of embodiment 26, wherein the polymeryl group is an ethylene/alpha-olefin multiblock interpolymeryl group.

32. The process of embodiment 25, wherein the polymeryl group is selected from the group consisting of a polymeryl group of a block composite, a polymeryl group of a specified block composite, and a polymeryl group of a crystalline block composite.

33. The process of embodiment 25, wherein the polymeryl group is a propylene-based polymeryl group.

34. The process of embodiment 33, wherein the polymeryl group is a propylene homopolymeryl group comprising units derived from propylene.

35. The process of embodiment 33, wherein the polymeryl group is a propylene/alpha-olefin interpolymeryl group comprising units derived from propylene and either ethylene or a C4-C30 alpha-olefin.

36. The process of embodiment 33, wherein the polymeryl group is a propylene/alpha-olefin copolymeryl group comprising units derived from propylene and either ethylene or a C4-C30 alpha-olefin.

37. The process of embodiment 35 or 36, wherein the C4-C30 alpha-olefin is selected from the group consisting of 1-butene, 1-hexene, and 1-octene.

38. The process of any of embodiments 10-22 and 25-37, where each polymeryl group has a number average molecular weight of greater than 365 g/mol.

39. The process of any of embodiments 10-22 and 25-38, where each polymeryl group has a number average molecular weight from greater than 365 g/mol to 10,000,000 g/mol, or from greater than 365 g/mol to 5,000,000 g/mol, or from greater than 365 g/mol to 1,000,000 g/mol, or from greater than 365 g/mol to 750,000 g/mol, or from greater than 365 g/mol to 500,000 g/mol, or from greater than 365 g/mol to 250,000 g/mol.

40. The process of any of embodiments 10-22 and 25-39, wherein each polymeryl group has a density from 0.850 to 0.965 g/cc, or from 0.860 to 0.950 g/cc, or from 0.865 to 0.925 g/cc.

41. The process of any of embodiments 10-22 and 25-40, wherein each polymeryl group has a melt index (I2) from 0.01 to 2,000 g/10 minutes, or from 0.01 to 1,500 g/10 minutes, or from 0.1 to 1,000 g/10 minutes, or from 0.1 to 500 g/10 minutes, or from 0.1 to 100 g/10 minutes.

42. The process of any of embodiments 10-22 and 25-41, wherein each polymeryl group has a number average molecular weight distribution (Mw/Mn) from 1 to 10, or from 1 to 7, or from 1 to 5, or from 2 to 4.

43. The process of any of the previous embodiments, wherein step a) is performed at a temperature from 15° C. to 100° C.

44. The process of any of the previous embodiments, wherein the organometallic compound of the formula (I) is prepared by a process comprising combining starting materials comprising:
i) an olefin monomer component; ii) a catalyst; and iii) a chain shuttling agent, thereby forming a solution or slurry comprising the organometallic compound of the formula (I).

45. The process of embodiment 44, wherein the organometallic compound of the formula (I) is prepared by a process comprising combining starting materials comprising:
i) an olefin monomer component; ii) a catalyst; and iii) a chain shuttling agent of the formula X₂Zn or X₃Al, wherein each X independently is a C1-C20 hydrocarbyl group,
thereby forming a solution or slurry comprising the organometallic compound of the formula (I).

46. The process of any of embodiments 1-44, wherein the organometallic compound of the formula (I) is prepared by a process comprising combining starting materials comprising:
i) an olefin monomer component; ii) a catalyst; and iii) a dual-headed chain shuttling,
thereby forming a solution or slurry comprising the organometallic compound of the formula (I).

### Test Methods

### Density:

Density is measured in accordance with ASTM D-792, Method B.

### Melt Index:

Melt index (I₂) is measured in accordance with ASTM D-1238, which is incorporated herein by reference in its entirety, Condition 190° C./2.16 kg, and was reported in grams eluted per 10 minutes.

### GPC:

Sample polymers are tested for their properties via GPC according to the following.

A high temperature Gel Permeation Chromatography system (GPC IR) consisting of an Infra-red concentration detector (IR-5) from PolymerChar Inc (Valencia, Spain) was used for Molecular Weight (MW) and Molecular Weight Distribution (MWD) determination. The carrier solvent was 1,2,4-trichlorobenzene (TCB). The auto-sampler compartment was operated at 160° C., and the column compartment was operated at 150° C. The columns used were four Polymer Laboratories Mixed A LS, 20 micron columns. The chromatographic solvent (TCB) and the sample preparation solvent were from the same solvent source with 250 ppm of butylated hydroxytoluene (BHT) and nitrogen sparged. The samples were prepared at a concentration of 2 mg/mL in TCB. Polymer samples were gently shaken at 160° C. for 2 hours. The injection volume was 200 μl, and the flow rate was 1.0 ml/minute.

Calibration of the GPC column set was performed with 21 narrow molecular weight distribution polystyrene standards. The molecular weights of the standards ranged from 580 to 8,400,000 g/mol, and were arranged in 6 “cocktail” mixtures, with at least a decade of separation between individual molecular weights.

The GPC column set was calibrated before running the examples by running twenty-one narrow molecular weight distribution polystyrene standards. The molecular weight (Mw) of the standards ranges from 580 to 8,400,000 grams per mole (g/mol), and the standards were contained in 6 “cocktail” mixtures. Each standard mixture had at least a decade of separation between individual molecular weights. The standard mixtures were purchased from Polymer Laboratories (Shropshire, UK). The polystyrene standards were prepared at 0.025 g in 50 mL of solvent for molecular weights equal to or greater than 1,000,000 g/mol and 0.05 g in 50 mL of solvent for molecular weights less than 1,000,000 g/mol. The polystyrene standards were dissolved at 80° C. with gentle agitation for 30 minutes. The narrow standards mixtures were run first and in order of decreasing highest molecular weight (Mw) component to minimize degradation. The polystyrene standard peak molecular weights were converted to polyethylene Mw using the Mark-Houwink constants. Upon obtaining the constants, the two values were used to construct two linear reference conventional calibrations for polyethylene molecular weight and polyethylene intrinsic viscosity as a function of elution column.

The polystyrene standard peak molecular weights were converted to polyethylene molecular weights using the following equation (as described in Williams and Ward, J. Polym. Sci., Polym. Let., 6, 621 (1968)):

$${M}_{polyethylene} = {A ( {M}_{polystyrene} )}^{B} \qquad ( 1 )$$

Here B has a value of 1.0, and the experimentally determined value of A is around 0.41.

A third order polynomial was used to fit the respective polyethylene-equivalent calibration points obtained from equation (1) to their observed elution volumes of polystyrene standards.

Number, weight, and z-average molecular weights were calculated according to the following equations:

$$\overline{Mn} = \frac{{\sum }^{i} {Wf}_{i}}{{\sum }^{t} ( W {f}_{i} / {M}_{i} )} \qquad ( 2 )$$

$$\overline{Mw} = \frac{{\sum }^{i} ( {Wf}_{i} * {M}_{i} )}{{\sum }^{i} {Wf}_{i}} \qquad ( 3 )$$

$$\overline{Mz} = \frac{{\sum }^{i} ( {Wf}_{i} * {M}_{i}^{2} )}{{\sum }^{i} ( {Wf}_{i} * {M}_{i} )} \qquad ( 4 )$$

Where, Wfᵢ is the weight fraction of the i-th component and Mi is the molecular weight of the i-th component.

The MWD was expressed as the ratio of the weight average molecular weight (Mw) to the number average molecular weight (Mn).

The accurate A value was determined by adjusting A value in equation (1) until Mw calculated using equation (3) and the corresponding retention volume polynomial, agreed with the known Mw value of 120,000 g/mol of a standard linear polyethylene homopolymer reference.

The GPC system consists of a Waters (Milford, Mass.) 150° C. high temperature chromatograph (other suitable high temperatures GPC instruments include Polymer Laboratories (Shropshire, UK) Model 210 and Model 220) equipped with an on-board differential refractometer (RI). Additional detectors could include an IR4 infra-red detector from Polymer ChAR (Valencia, Spain), Precision Detectors (Amherst, Mass.) 2-angle laser light scattering detector Model 2040, and a Viscotek (Houston, Tex.) 150R 4-capillary solution viscometer. A GPC with the last two independent detectors and at least one of the first detectors is sometimes referred to as “3D-GPC”, while the term “GPC” alone generally refers to conventional GPC. Depending on the sample, either the 15-degree angle or the 90-degree angle of the light scattering detector was used for calculation purposes.

Data collection was performed using Viscotek TriSEC software, Version 3, and a 4-channel Viscotek Data Manager DM400. The system was equipped with an on-line solvent degassing device from Polymer Laboratories (Shropshire, UK). Suitable high temperature GPC columns could be used, such as four 30 cm long Shodex HT803 13 micron columns or four 30 cm Polymer Labs columns of 20-micron mixed-pore-size packing (MixA LS, Polymer Labs). The sample carousel compartment was operated at 140° C. and the column compartment was operated at 150° C. The samples were prepared at a concentration of 0.1 grams of polymer in 50 milliliters of solvent. The chromatographic solvent and the sample preparation solvent contain 200 ppm of butylated hydroxytoluene (BHT). Both solvents were sparged with nitrogen. The polyethylene samples were gently stirred at 160° C. for four hours (4 h). The injection volume was 200 microliters (p L). The flow rate through the GPC was set at 1 mL/minute.

### NMR:

NMR analysis was performed at room temperature using a standard NMR solvent, such as chloroform or benzene, and data was acquired on a Varian 500 MHz spectrometer.

The diffusion NMR experiment employed 2048 scans and a repetition time of 15 s. The spectrum was centered at 90 ppm and covered a bandwidth of 240 ppm. Self-diffusion coefficient (D) was measured by ¹H and ¹³C-detected diffusion using the pulsed-field-gradient NMR with double stimulated echo to mitigate any artifact by thermal convection. In general, the method utilized spatial variation of magnetic field, i.e. magnetic field gradient (g), to physically label the spatial positions of molecular ensembles during a well-defined time interval, thereby coupling the NMR peak intensity to the self-diffusion (D) of each molecule. D is quantified using the Stejskal-Tanner equation (Eq. 1), where I and I₀ represent the NMR signal intensity with/without gradient. γ is the gyromagnetic ratio of nuclei, g is gradient strength, δ is the gradient pulse duration and A is the diffusion time. Bearing in mind that peaks from the same molecule must yield the same D, such a method enables inherent separation of NMR peaks by virtue of D associated with each peak without perturbing the spectra resolution. This method in nature can also be considered as an analogue to the size exclusion chromatography (SEC), i.e. large molecule diffuses slow/elute early or vice versa. Thus, the measurement provides explicit intermolecular information to reveal if the polymer backbone is capped by a specific end group by comparing D_{end} vs. D_{backbone}.

$$I = {I}_{0} exp ( - D {γ}^{2} {δ}^{2} {g}^{2} ( Δ - \frac{δ}{3} ) ) \qquad ( 1 )$$

### High Temperature Thermal Gradient Interaction Chromatography:

A commercial Crystallization Elution Fractionation instrument (CEF) (Polymer Char, Spain) was used to perform the high temperature thermal gradient interaction chromatography (HT-TGIC, or TGIC) measurement (Cong, et al., Macromolecules, 2011, 44 (8), 3062-3072.). The CEF instrument is equipped with IR-4 detector or IR-5 detector. Graphite is known to be used as HT TGIC column (Freddy, A. Van Damme et al., U.S. Pat. No. 8,476,076B2; Winniford et al., U.S. Pat. No. 8,318,896.). A single graphite column (250×4.6 mm) was used for separation. Graphite (Superior Graphite AR22) is packed into a column by using dry packing technique followed by slurry packing technique (Cong et al., EP 2714226B1 and the references cited). An “8 cm×0.48 cm ( 3/16 inch ID)” stainless steel column packed with 27 micron glass beads (Catalog #GL01918/20-27 um, MO-SCI Specialty Products, LLC, Rolla, MO, USA), was installed in front of the IR detector, in the top oven of the CEF instrument. The experimental parameters were: top oven/transfer line/needle temperature at 150° C., dissolution temperature at 150° C., dissolution stirring setting of 2. pump stabilization time of 15 seconds, a pump flow rate of cleaning column at 0.500 mL/m, pump flow rate of column loading at 0.300 ml/min, stabilization temperature at 150° C., stabilization time (pre, prior to load to column) at 2.0 min, stabilization time (post, after loaded to column) at 1.0 min, SF (Soluble Fraction) time at 5.0 min, cooling rate of 3.00° C./min from 150° C. to 30° C., flow rate during cooling process of 0.04 ml/min, heating rate of 2.00° C./min from 30° C. to 160° C., isothermal time at 160° C. for 10 min, elution flow rate of 0.500 mL/min, and an injection loop size of 200 microliters.

The flow rate during cooling process was adjusted according to the length of graphite column such that all polymer fractions must remain on the column at the end of cooling cycle.

Samples were prepared by the PolymerChar autosampler at 150° C., for 120 minutes, at a concentration of 4.0 mg/ml in ODCB (defined below). Silica gel 40 (particle size 0.2-0.5 mm, catalogue number 10181-3, EMD) was dried in a vacuum oven at 160° C., for about two hours, prior to use. 2,6-di-tert-butyl-4-methylphenol (1.6 grams, BHT, catalog number B1378-500G, Sigma-Aldrich) and the silica gel 40 (5.0 grams) were added to two liters of ortho-dichlorobenze (ODCB, 99% anhydrous grade, Sigma-Aldrich). For the CEF instrument equipped with an autosampler with N2 purging capability, Silica gel 40 is packed into two 300×7.5 mm GPC size stainless steel columns and the Silica gel 40 columns are installed at the inlet of the pump of the CEF instrument to dry ODCB; and no BHT is added to the mobile phase. This “ODCB containing BHT and silica gel” or ODCB dried with silica gel 40 is now referred to as “ODCB.” The TGIC data was processed on a PolymerChar (Spain) “GPC One” software platform. The temperature calibration was performed with a mixture of about 4 to 6 mg Eicosane, 14.0 mg of isotactic homopolymer polypropylene iPP (polydispersity of 3.6 to 4.0, and molecular weight Mw reported as polyethylene equivalent of 150,000 to 190,000, and polydispersity (Mw/Mn) of 3.6 to 4.0, wherein the iPP DSC melting temperature was measured to be 158-159 C (DSC method described herein below). 14.0 mg of homopolymer polyethylene HDPE (zero comonomer content, Mw reported as polyethylene equivalent as 115,000 to 125,000, and polydispersity of 2.5 to 2.8), in a 10 mL vial filled with 7.0 mL of ODCB. The dissolution time was 2 hours at 160° C.

The calibration process (30° C. to 150° C. for Eicosane elution and HDPE elution) consists of the following steps:
a. Extrapolate eluting temperature for each of the isothermal steps during elution according to heating rate.
b. Calculate the delay volume. Shift the temperature (x-axis) corresponding to the IR measurement channel chromatogram (y-axis), so that the Eicosane peak maximum (y-axis) is coincident with elution temperature at 30.0° C. The delay volume is calculated from the temperature difference (30° C.—the actual elution temperature of Eicosane peak maximum) divided by the heating rate of the method, and then multiplied by the elution flow rate.
c. Adjust each recorded elution temperature with this same delay volume adjustment.
d. Linearly scale the heating rate, such that the observed HDPE reference has an elution peak maximum temperature of 150.0° C., while the Eicosane elution peak maximum temperature remains at 30.0° C.

Data processing for polymer samples of TGIC is described below.

A solvent blank (pure solvent injection) was run at the same experimental conditions as the polymer samples. Data processing for polymer samples includes: subtraction of the solvent blank for each detector channel, temperature extrapolation as described in the calibration process, compensation of temperature with the delay volume determined from the calibration process, and adjustment in elution temperature axis to the 30° C. and 160° C. range as calculated from the heating rate of the calibration.

The chromatogram (measurement channel of IR-4 detector or IR-5 detector) was integrated with PolymerChar “GPC One” software. A straight baseline was drawn from the visible difference, when the peak falls to a flat baseline (roughly a zero value in the blank subtracted chromatogram) at high elution temperature and the minimum or flat region of detector signal on the high temperature side of the soluble fraction (SF).

### Transmission Electron Microscopy (TEM)

The polymer was solvent cast and evaporated on to a 2 mm thick glass slide containing two concave circular wells. Solvent cast polymer was sequentially added to the wells after evaporation until sufficient material could be collected for analysis. The same deposition process was carried out by the client for a physical blend and diblock formulation.

A stainless steel spatula was used to remove enough material from the glass slide well for analysis. The deposit was carefully applied to a cryogenic pin mount. A razor blade was used to create a fine point in the tacky polymer on the end of the pin mount for section collection. Samples were cryogenically cross sectioned at −80 C using a diamond knife on a Leica EM UC7 microtome equipped with and FC7 cryosectioning chamber. Sections of approximately 100 nanometers in thickness were placed onto 100 mesh, formvar coated, carbon reinforced copper TEM grids. The sections were post stained with the vapor phase of an aqueous 0.5% ruthenium tetraoxide solution for 10 minutes at ambient temperature. Images were captured using a JEOL JEM-1230 transmission electron microscope operated at 100 kV accelerating voltage and collected with a Gatan OneView digital camera using Gatan digital micrograph suite.

### EXAMPLES

The following examples are intended to illustrate some embodiments of the invention and should not be interpreted as limiting the scope of the invention set forth in the claims.

Unless stated otherwise, all materials and reagents are commercially available, such as from Sigma Aldrich.

### Example 1

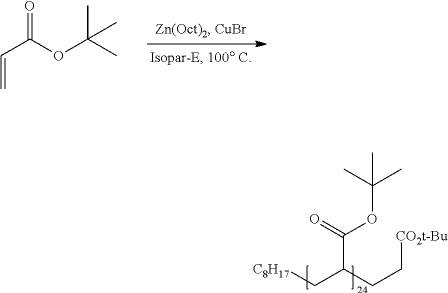

The reaction was carried out in a nitrogen atmosphere glovebox. Prior to the start of the reaction, the t-butyl acrylate through an alumina syringe cartridge to remove the inhibitor. 34 mg CuBr (0.237 mmol) and 0.860 mL t-butyl acrylate (5.92 mmol, 50 equiv.) were added to a 20 mL vial equipped with a magnetic stirbar. This was followed by the addition of 0.500 mL of a 0.238 M Zn(Oct)₂ solution in Isopar-E (0.119 mmol, 0.5 equiv.). The solution was allowed to stir at 100° C. The reaction continued stirring at 100° C. overnight. The vial was removed from the glovebox and a few drops of water were added to quench the reaction. The polymer was redissolved in THE and passed through a short alumina plug to remove Cu and Zn salts. THE was removed by rotary evaporation and chlorobenzene was added and the mixture allowed to stir for 10 minutes before drying under vacuum overnight at 70° C.

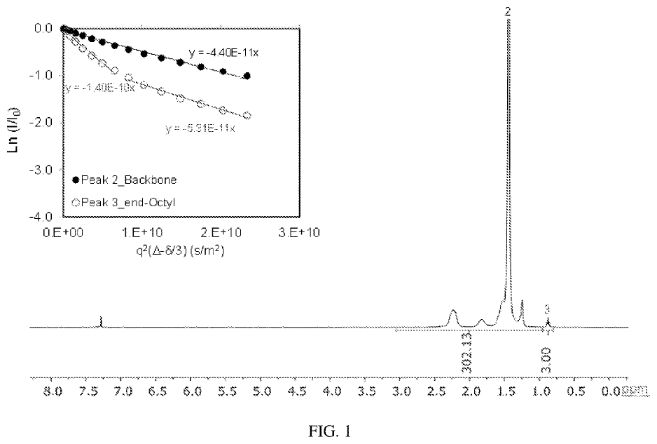

By GPC, Mw=21274, Mn=4175, PDI=5.09, and #t-butyl acrylate monomer units=25. FIG. 1 provides the ¹H NMR with diffusion measurements for reaction of Zn(Oct)₂ and t-butyl acrylate (CuBr, 100° C.).

### Example 2

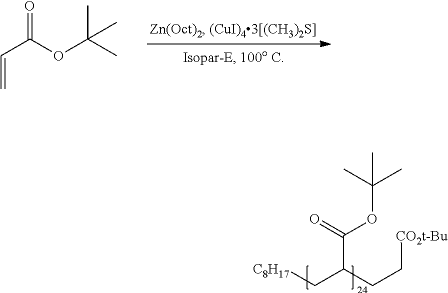

The reaction was carried out in a nitrogen atmosphere glovebox. Prior to the start of the reaction, the t-butyl acrylate through an alumina syringe cartridge to remove the inhibitor. 60 mg of (CuI)4·3[(CH3)2S complex (0.063 mmol, 0.53 equiv.) and 0.860 mL t-butyl acrylate (5.92 mmol, 50 equiv.) were added to a 20 mL vial equipped with a magnetic stirbar. This was followed by the addition of 0.500 mL of a 0.238 M Zn(Oct)₂ solution in Isopar-E (0.119 mmol). The solution was allowed to stir at 100° C. overnight. After several hours, the solution turned viscous indicating polymerization had taken place. A few drops of water was added to quench the reaction and THE was added to redissolve the polymer and the mixture was passed through an alumina plug to remove Cu and Zn salts. To remove THF, chlorobenzene was added to the solution and allowed to stir for 20 minutes. The polymer was dried under vacuum overnight at 70° C.

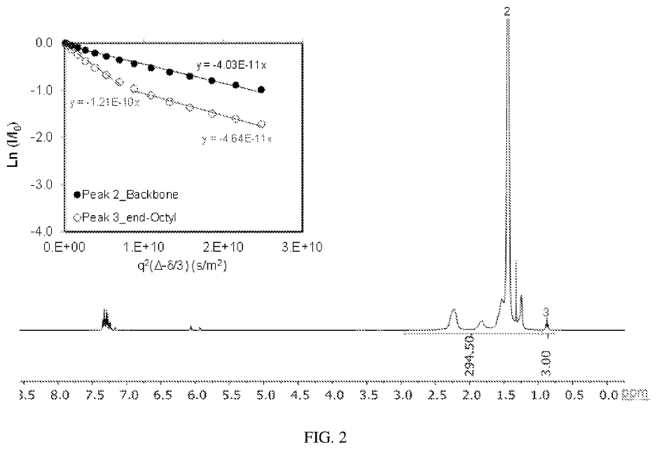

By GPC, Mw=22215, Mn=6617, PDI=3.36, and #t-butylacrylate monomer units=25. FIG. 2 provides the ¹H NMR with diffusion measurements for reaction of Zn(Oct)₂ and t-butyl acrylate (CuI)₄·3[(CH₃)₂S], 100° C.)

### Example 3

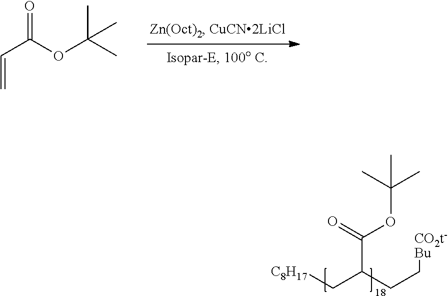

The reaction was carried out in a nitrogen atmosphere glovebox. Prior to the start of the reaction, the t-butyl acrylate through an alumina syringe cartridge to remove the inhibitor. 0.238 mL 1.0 M CuCN·2LiCl (0.238 mmol) and 0.860 mL t-butyl acrylate (5.92 mmol, 50 equiv.) were added to a 20 mL vial equipped with a magnetic stirbar. This was followed by the addition of 0.500 mL of a 0.238 M Zn(Oct)₂ solution in Isopar-E (0.119 mmol, 0.5 equiv.). The solution was allowed to stir at 100° C. overnight. After several hours, the solution turned viscous indicating polymerization had taken place. A few drops of water was added to quench the reaction and THE was added to redissolve the polymer and the mixture was passed through an alumina plug to remove Cu and Zn salts. To remove THF, chlorobenzene was added to the solution and allowed to stir for 20 minutes. The polymer was dried under vacuum overnight at 70° C.

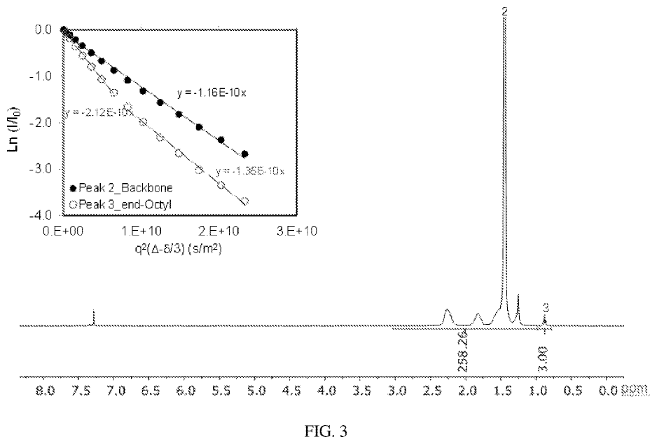

By GPC, Mw=6895, Mn=2821, PDI=2.44, and #monomer units=19. FIG. 3 provides the ¹H NMR with diffusion measurements for reaction of Zn(Oct)₂ and t-butyl acrylate (CuCN·2LiCl, 100° C.)

### Example 4

ZnPE₂ was prepared in a a 2 L Parr batch reactor designed specifically for copolymerizations of ethylene, propylene, 1-octene, 4-methyl-1-pentene, as well as other unsaturated co-monomers, as needed. The reactor is heated by an electrical heating mantle, and is cooled by an internal serpentine cooling coil containing cooling water. The water is pre-treated by passing through an Evoqua water purification system. Both the reactor and the heating/cooling system are controlled and monitored by a Camile TG process computer. All chemicals used for polymerization or catalyst makeup are run through purification columns, to remove any impurities that may effect polymerization. The 1-octene, toluene and Isopar™ E were passed through 2 columns, the first containing A2 alumina, the second containing Q5 reactant. The ethylene was passed through 2 columns, the first containing A204 alumna and 4 A mole sieves, the second containing Q5 reactant. The N2, used for transfers, was passed through a single column containing A204 alumna, 4 A mole sieves and Q5 reactant.

The reactor is loaded first from the shot tank that contains Isopar-E. The shot tank is filled to the load setpoints by use of a differential pressure transducer. After solvent addition, the reactor is heated up to the polymerization temperature setpoint. The ethylene is added to the reactor when at reaction temperature to maintain reaction pressure setpoint. Ethylene addition amounts are monitored by a micro-motion flow meter.

The polymerization catalyst I-((2,6-diisopropylphenyl)(2-methyl-3-(octylimino)butan-2-yl)amino)trimethyl hafnium was obtained from Boulder Scientific Co. and prepared according to methods known in the art. The catalyst and activator(s) were mixed with the appropriate amount of toluene to achieve a desired concentration. The catalyst and activator(s) were handled in an inert glovebox, drawn into a syringe and pressure transferred into the catalyst shot tank. This was followed by 3 rinses of toluene, 5 mL each. Before ethylene addition, 10 μmoles of MMAO was added to the reactor through the catalyst shot tank. Catalyst and activator was added when reactor pressure setpoint was achieved. Diethylzinc (DEZ) is additionally added as a chain-shuttling agent.

Immediately after catalyst addition the run timer begins. Usually within the first 2 min. of successful catalyst runs, an exotherm was observed, as well as decreasing reactor pressure. Ethylene was then added to maintain reaction pressure setpoint in the reactor. These polymerizations were run for 10 min., then the agitator was stopped. Instead of transferring the contents of the dump pot to a sample tray, this experiment used an Argon inerting method in order to transfer a sealed dump pot to a nitrogen filled glove box where the contents were collected in containers. When the contents of the reactor were emptied into the dump pot, the normal flow of nitrogen inerting was switched to argon, via a ball valve. The argon flowed for a calculated period of time to allow five exchanges of the volume of gas in the pot. When the argon inerting was complete, the dump pot was lowered from its fixture, and a secondary lid with inlet and outlet valves was sealed to the top of the pot. The pot was then inerted with argon for an additional five exchanges of gas, via a supply line and inlet/outlet valves. When complete, the valves were closed. The pot was then transferred to a glove box without the contents coming into contact with the outside atmosphere. A clean pot was used for this run, and was stored in an oven at 130° C. for greater than 60 minutes prior to use, in order to drive off any excess water absorbed by the metal surface.

An aliquot of the material was quenched with methanol, dried, and analyzed by GPC to determine the molecular weight.

For all experiments, the ZnPE₂ was used as received as a solution in Isopar-E.

TABLE 1

| | Mw | Mn | PDI |
|---|---|---|---|
| Quenched PE | 1523 | 1416 | 1.08 |

Reaction of ZnPE₂ and 2-ethylhexyl acrylate (60, 90, 120, 200, 360 equiv.)

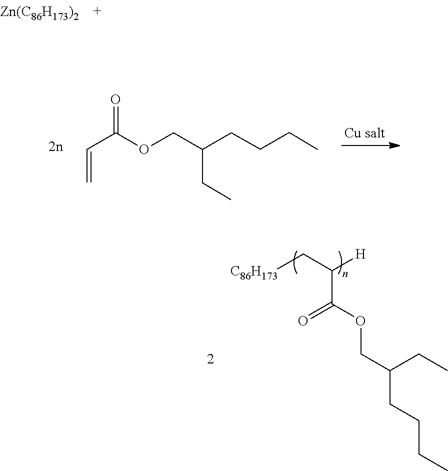

Reaction was carried out in a nitrogen-atmosphere glovebox. The concentration of active PE-Zn chains in the solution of ZnPE₂ in Isopar-E was determined by titration with iodine and found to be 0.049 mmol per gram of solution. 3 g of the ZnPE₂ solution (0.147 mmol active polymer chains) was added to separate 40 mL vials containing a magnetic stirbar. The 2-ethylhexyl acrylate (2EHA) (60, 90, 120, 200, 360 equiv. with respect to active PE chains) was added dropwise to the stirring ZnPE₂ solution, followed by addition of 35 mg (CuI)₄·3[(CH₃)₂S] (1 equiv. with respect to active PE chains). The reaction mixture was stirred at 100° C. overnight. Polymer was precipitated by the addition of methanol.

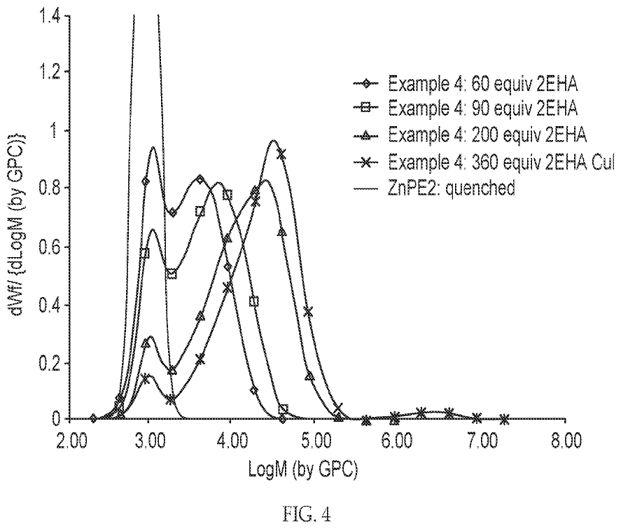

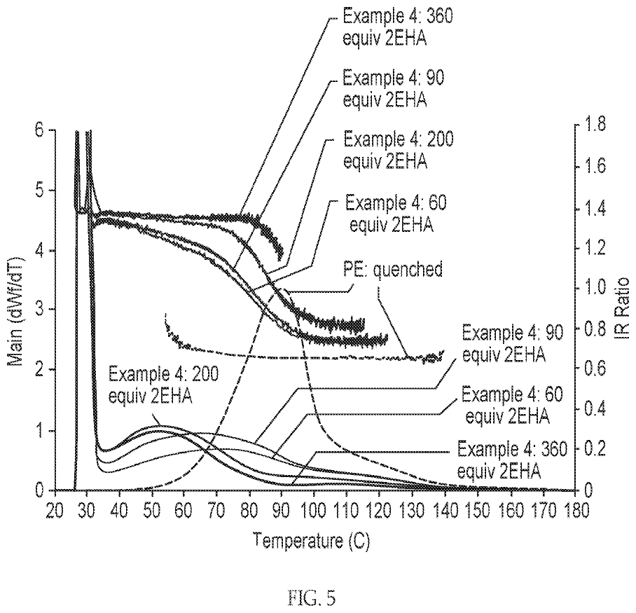

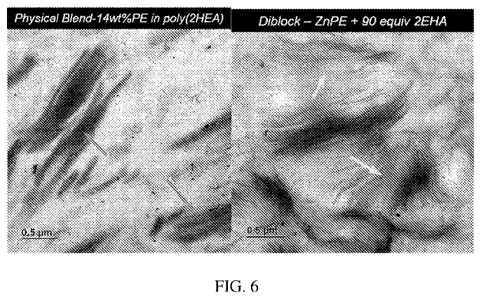

Polymer was characterized by gel permeation chromatography (GPC) (FIG. 4), thermal gradient interaction chromatography (TGIC) (FIG. 5), and transmission electron microscopy (TEM) (FIG. 6).

FIG. 4 shows the GPC traces of the quenched ZnPE₂ species overlayed with polymers formed via reaction of ZnPE₂ with varying amounts of 2EHA (60, 90, 120, and 200 equiv. with respect to active PE chains calculated from iodine titration) in the presence of (CuI)₄·3[(CH₃)₂S]. As the amount of 2EHA added increases, the molecular weight of the resulting polymer increases in an amount consistent with a longer acrylate block in a diblock copolymer.

GPC also shows the presence of polymer with molecular weights consistent with the starting PE. The presence of PE homopolymer can either be due to either ineffective 2EHA polymerization yield or the presence of “dead” chains in the original polymerylzinc sample. Dead chains can form via chain termination during polymerization or partial quenching of the sample due to the presence of impurities. In these cases, the chains are no longer bound to zinc and cannot participate in block copolymer formation.

FIG. 5 shows a TGIC overlay of different diblock samples prepared with varying amount of 2EHA (60-360 equivalents with respect to active PE) in the presence of (CuI)₄·3[(CH₃)₂S]. All samples exhibit an intermediate elution temperature between that of poly(2EHA) and PE homopolymer. Furthermore, the elution temperature appears to shift from more PE-like to more poly(2EHA)-like as the equivalents of 2EHA added increases.

Finally, with reference to FIG. 6, optical microscopy and TEM analysis were carried out on a PE/poly(2EHA) physical blend sample as well as one of the block samples (ZnPE₂ reacted with 90 equivalents of 2EHA in the presence of (CuI)₄·3[(CH₃)₂S]). A physical blend showed two distinct phases: a high contrast, dispersed crystalline phase and a lighter contrast continuous matrix. The crystalline phase consists of dense lamellae stacks, presumed to be PE crystals. Conversely, the block sample produced a much finer, more homogenous morphology in which crystalline structures were more networked within the matrix phase. The fine crystalline lamellae in the block sample appears more exfoliated within the matrix phase compared to the dense lamellae stacks observed in a physical blend.

1. A process for preparing an olefin-acrylate block copolymer, the process comprising:
a) combining starting materials comprising an organometallic compound, an acrylate monomer, and a metal salt component,
thereby forming a product comprising the olefin-acrylate block copolymer, wherein:
the metal salt component comprises a metal salt, a metal salt complex, or combinations thereof;
the organometallic compound has the formula (I): 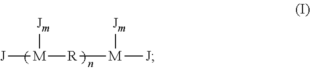
the acrylate monomer has the formula (II): 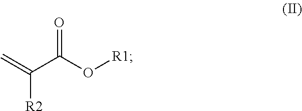
the olefin-acrylate block copolymer has the formula (III): 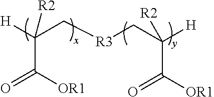
n is greater than or equal to 0;
each M independently is aluminum or zinc;
if an M is zinc, then the subscript m of the attached J is equal to 0;
if an M is aluminum, then the subscript m of the attached J is equal to 1;
each R and J independently is a C1-C26 hydrocarbyl group or a polymeryl group,
wherein each R and J may be the same or different;
each R1 independently is a C1-C30 hydrocarbyl group;
each R2 independently is hydrogen or a methyl group;
R3 is J when n is equal to 0, and R3 is R when n is greater than 0;
x is equal to 0 or a number from 2 to 500;
x is equal to 0 when n is equal to 0; and
y is a number from 2 to 500.

2. The process of claim 1, wherein the starting materials of step a) further comprise a solvent.

3. The process of claim 1, wherein the metal salt or metal salt complex is a copper salt or copper salt complex.

4. The process of claim 1, wherein the metal salt or metal salt complex is a copper salt or copper salt complex selected from the group consisting of: CuBr; CuCN·2LiCl; (CuI)₄·3[(CH₃)₂S]; CuBr₂; CuBr·CH₃SCH₃; CuCl; CuCl₂; CuTC (copper thiophene-2-carboxylate); Cu(OAc); CuSPh; [C₆H₁₁(CH₂)₃CO₂]₂Cu; CuF₂; C₁₂H₂₂CuO₁₄; Cu(OH)₂; CuI; Cu(NO₃)₂; CuSCN; and combinations thereof.

5. The process of claim 1, wherein each R independently is a C1-C26 hydrocarbyl group.

6. The process of claim 1, where each R independently is a polymeryl group that has a number average molecular weight of greater than 365 g/mol.

7. The process of claim 1, wherein each J independently is a C1-C26 hydrocarbyl group.

8. The process of claim 1, wherein each J independently is a polymeryl group that has a number average molecular weight of greater than 365 g/mol.

9. The process of claim 6, wherein the polymeryl group is an ethylene-based polymeryl group.

10. The process of claim 1, wherein each M is zinc, each m is equal to 0, n is equal to 0, x is equal to 0, and each J independently is a C1-C26 hydrocarbyl group or a polymeryl group.
